(19) United States
(12) Patent Application Publication
(10) Pub. No.: US 2025/0033479 A1
(43) Pub. Date: Jan. 30, 2025

(54) VEHICLE DEVICE

(71) Applicant: CARUX TECHNOLOGY PTE. LTD., SINGAPORE (SG)

(72) Inventors: Ta-Chin Huang, Tainan (TW); Ching-I Lo, Tainan (TW)

(73) Assignee: CARUX TECHNOLOGY PTE. LTD., SINGAPORE (SG)

(21) Appl. No.: 18/757,510

(22) Filed: Jun. 28, 2024

(30) Foreign Application Priority Data
Jul. 25, 2023 (CN) 202310916690.4

(51) Int. Cl. B60K 35/53; B60K 35/22

(52) U.S. Cl. CPC B60K 35/53; B60K 35/22; B60K 35/223; B60K 2360/688; B60K 2360/693; B60K 2360/816

(57) ABSTRACT

The disclosure provides a vehicle device including a first display and a control structure. The first display includes a first frame, a first display unit, and a first connecting structure. The first frame includes a first sub-frame and a second sub-frame. The first display unit is disposed on the first frame. The first connecting structure is connected to the first sub-frame and the second sub-frame. The control structure is connected to the first sub-frame and the second sub-frame. The first display is deformed from a first shape to a second shape by the control structure.

### CROSS-REFERENCE TO RELATED APPLICATION

This application claims the priority benefit of China application serial no. 202310916690.4, filed on Jul. 25, 2023. The entirety of the above-mentioned patent application is hereby incorporated by reference herein and made a part of this specification.

### BACKGROUND

### Technical Field

The disclosure relates to an electronic device, and in particular to a vehicle device.

### Description of Related Art

Currently, the screens used in vehicle displays all have a fixed shape, meaning that the screens cannot be deformed. Therefore, images from different directions may not be provided for the driver and/or the passenger to view, and the screens are limited and inconvenient in use.

### SUMMARY

The disclosure is directed to a vehicle device that may change the shape of the display to provide images from different directions.

According to an embodiment of the disclosure, a vehicle device includes a first display and a control structure. The first display includes a first frame, a first display unit, and a first connecting structure. The first frame includes a first sub-frame and a second sub-frame. The first display unit is disposed on the first frame. The first connecting structure is connected to the first sub-frame and the second sub-frame. The control structure is connected to the first sub-frame and the second sub-frame. The first display is deformed from a first shape to a second shape by the control structure.

According to an embodiment of the disclosure, a vehicle device includes a plurality of displays, a cover plate, and a control structure. The plurality of displays include a first curved display and a second curved display. The cover plate covers the plurality of displays. The control structure is connected to the first curved display and the second curved display, wherein the plurality of displays are deformed from a first shape to a second shape by the control structure.

According to an embodiment of the disclosure, a vehicle device includes a vehicle body, a display and a control structure. The vehicle body has a first curved shape and includes a cavity. The display is disposed within the cavity, and includes a frame, a backlight module and a display unit. The backlight module is disposed on the frame, and the display unit is disposed on the backlight module. The control structure is disposed within the cavity and connected to the display, wherein the display is deformed from a first shape to a second shape by the control structure.

Based on the above, in an embodiment of the disclosure, the display may be deformed from the first shape to the second shape by the control structure, meaning that the screen appearance may be changed. Therefore, the vehicle device of the disclosure may provide images from different directions such that the driver and/or the passenger may have a better visual experience.

In order to make the above-mentioned features and advantages of the disclosure more comprehensible, the following specific embodiments are described in detail with reference to the accompanying drawings.

### BRIEF DESCRIPTION OF THE DRAWINGS

The accompanying drawings are included to further understand the disclosure, and the drawings are incorporated in the specification and constitute a part of the specification. The drawings illustrate embodiments of the disclosure and, together with the description, serve to explain the principles of the disclosure.

FIG. 1 is a schematic diagram of a vehicle device disposed in a car of an embodiment of the disclosure.

FIG. 2A is a schematic three-dimensional diagram of the vehicle device of FIG. 1 in a first position.

FIG. 2B is a schematic three-dimensional diagram of FIG. 2A from another perspective.

FIG. 2C is a schematic three-dimensional diagram of the vehicle device of FIG. 1 in a second position.

FIG. 2D is a schematic three-dimensional diagram of FIG. 2C from another perspective.

FIG. 2E is a schematic cross-sectional view along line I-I of FIG. 2B.

FIG. 2F is a schematic cross-sectional view along line II-II of FIG. 2B.

FIG. 3A to FIG. 3D are schematic three-dimensional diagrams of various first connecting structures and first frames of a plurality of embodiments of the disclosure.

FIG. 4A is a schematic three-dimensional diagram of another vehicle device in a first position of an embodiment of the disclosure.

FIG. 4B is a schematic three-dimensional diagram of the vehicle device of FIG. 4A in a second position.

FIG. 4C is a schematic three-dimensional exploded diagram of the first display of FIG. 4A.

FIG. 5A is a schematic three-dimensional diagram of another vehicle device in a first position of an embodiment of the disclosure.

FIG. 5B is a schematic three-dimensional diagram of the vehicle device of FIG. 5A in a second position.

FIG. 6A is a schematic three-dimensional diagram of another vehicle device in a first position of an embodiment of the disclosure.

FIG. 6B is a schematic three-dimensional diagram of the vehicle device of FIG. 6A in a second position.

FIG. 6C is a schematic three-dimensional exploded diagram of one display of FIG. 6A.

FIG. 7A is a schematic three-dimensional diagram of another vehicle device in a first position of an embodiment of the disclosure.

FIG. 7B is a schematic three-dimensional diagram of the vehicle device of FIG. 7A in a second position.

FIG. 8A is a schematic three-dimensional diagram of another vehicle device in a first position of an embodiment of the disclosure.

FIG. 8B is a schematic three-dimensional diagram of the vehicle device of FIG. 8A in a second position.

FIG. 8C is schematic diagram illustrating the display and the control structure in the first position and the second position as shown in FIG. 8A and FIG. 8B.

FIG. 9A to FIG. 9B are schematic diagram illustrating the display and various control structure in the first position and the second position.

### DESCRIPTION OF THE EMBODIMENTS

The disclosure may be understood by referring to the following detailed description in conjunction with the accompanying drawings. It should be noted that in order to facilitate understanding to the reader and to simplify the drawings, the multiple drawings in the disclosure depict a part of the electronic device, and certain elements in the drawings are not drawn to actual scale. In addition, the quantity and the dimension of each of the elements in the figures are for illustration, and are not intended to limit the scope of the disclosure.

Certain terms are used throughout the specification and the appended claims of the disclosure to refer to particular elements. Those skilled in the art should understand that electronic equipment manufacturers may refer to the same elements under different names. This article does not intend to distinguish between those elements that have the same function but have different names.

In the following specification and claims, words such as “containing” and “including” are open-ended words, so they should be interpreted as meaning “containing but not limited to . . . .”

In addition, relative terms, such as “below” or “bottom” and “above” or “top”, may be used in the embodiments to describe the relative relationship of one element of the drawing to another element. It will be understood that if the device in the figures is turned upside down, elements described as being on the “lower” side would then be elements described as being on the “upper” side.

In some embodiments of the disclosure, terms related to joining, connecting, such as “connecting”, “interconnecting”, etc., unless otherwise specified, may mean that two structures are in direct contact, or it may also mean that the two structures are not in direct (indirect) contact, and there are other structures disposed between the two structures. Moreover, the terms of bonding and connecting may also include the case where both structures are movable or both structures are fixed. Moreover, the term “coupling” includes the transfer of energy between two structures via direct or indirect electrical connection, or the transfer of energy between two separate structures via mutual induction.

It should be understood that, when an element or film is referred to as being “on” or “connected to” another element or film, it may be directly on or directly connected to this other element or layer, or there may be an intervening element or layer in between (indirect case). In contrast, when an element is referred to as being “directly on” or “directly connected to” another element or layer, there are no intervening elements or layers present.

In the disclosure, length, width, thickness, height or area, or distance or pitch between components may be measured using an optical microscope (OM), a scanning electron microscope (SEM), a film thickness profiler (a-step), an ellipse thickness gauge, or other suitable methods. In detail, according to some embodiments, a cross-sectional structure image including the component to be measured may be obtained, and the length, width, thickness, height, or area of each component, or the distance or pitch between components may be measured using an SEM, but the disclosure is not limited thereto.

Moreover, the terms “the given range is from the first value to the second value” and “the given range falls within the range of the first value to the second value” mean that the given range includes the first value, the second value, and other values therebetween. If the first direction is perpendicular to the second direction, the angle between the first direction and the second direction may be between 80 degrees and 100 degrees; if the first direction is parallel to the second direction, the angle between the first direction and the second direction may be between 0 degrees and 10 degrees. The terms “about”, “equal to”, “equal” or “identical”, “substantially” or “roughly” are generally interpreted as being within 20% of a given value or range, or interpreted as being within 10%, 5%, 3%, 2%, 1%, or 0.5% of a given value or range.

Although the terms first, second, third . . . may be used to describe various constituent elements, the constituent elements are not limited to these terms. This term is used to distinguish a single constituent element from other constituent elements in the specification. The same terms may be not used in the claims, but are replaced by first, second, third . . . in the order in which elements are declared in the claims. Therefore, in the following specification, a first constituent element may be a second constituent element in the claims.

Unless otherwise defined, all terms (including technical and scientific terms) used herein have the same meaning as commonly understood by one of ordinary skill in the art to which this disclosure belongs. It may be understood that these terms, such as those defined in commonly used dictionaries, should be interpreted as having a meaning consistent with the background or context of the related techniques and the disclosure, and should not be interpreted in an idealized or overly formal manner, unless otherwise defined herein.

It should be noted that in the following embodiments, the technical features in several different embodiments may be replaced, recombined, and mixed to complete other embodiments without departing from the spirit of the disclosure.

Hereinafter, reference will be made in detail to exemplary embodiments of the disclosure, and examples of the exemplary embodiments are illustrated in the figures. Wherever possible, the same reference numerals are used in the figures and the descriptions to refer to the same or similar portions.

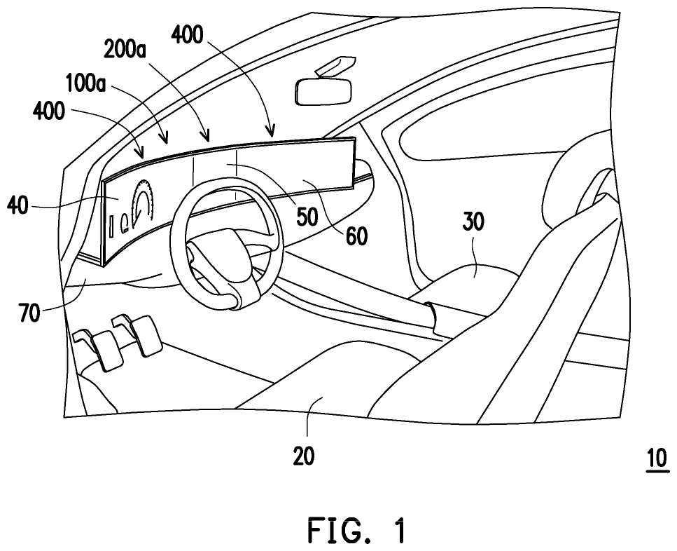

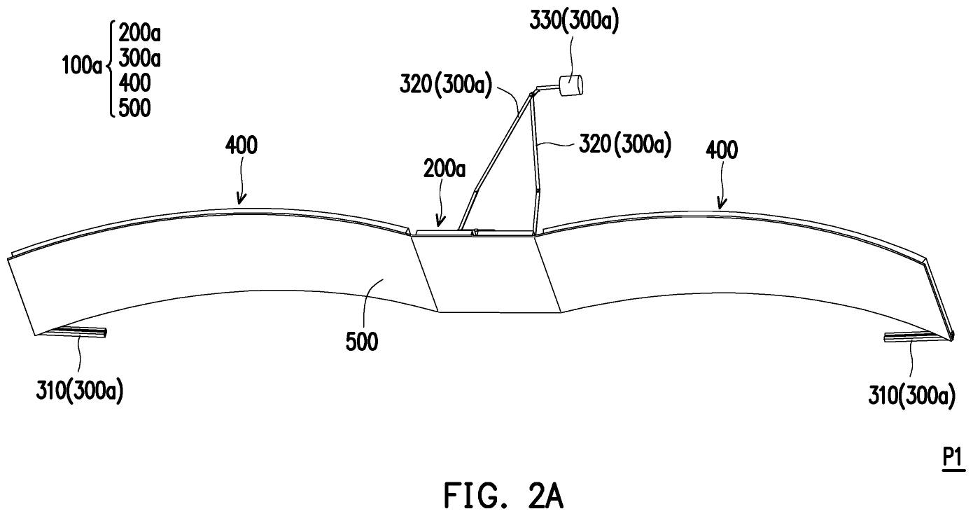

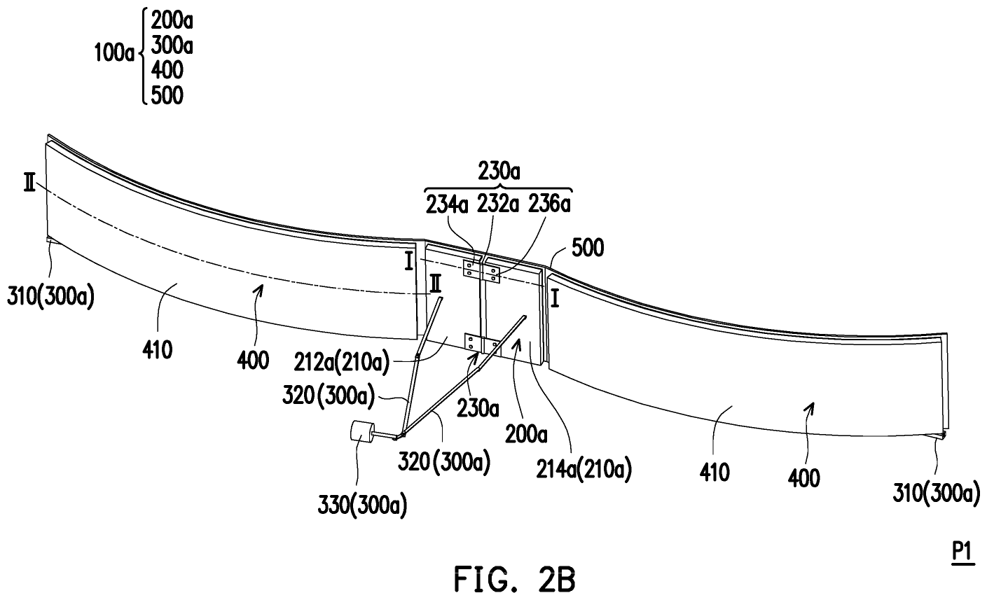

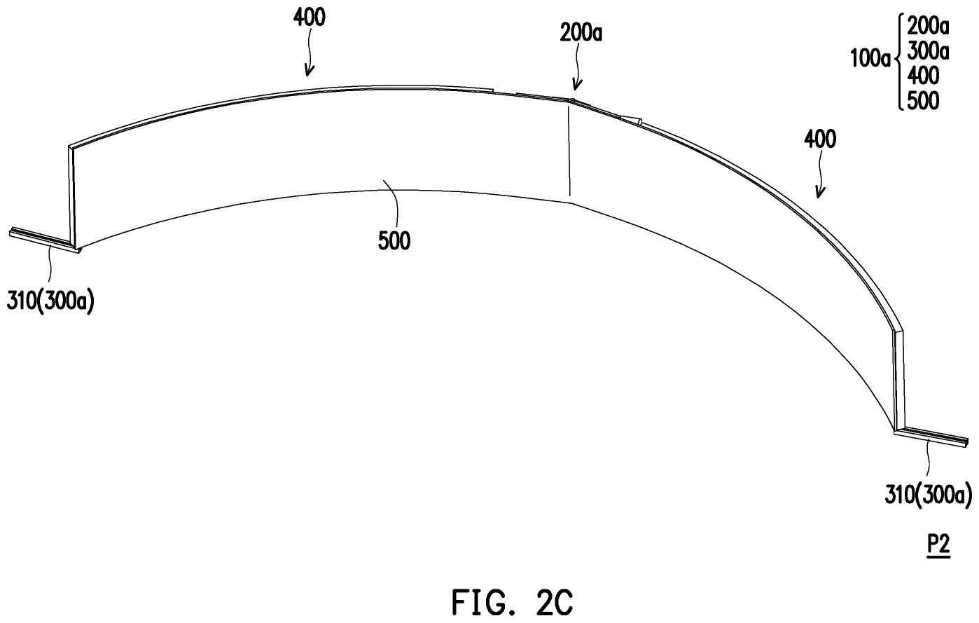

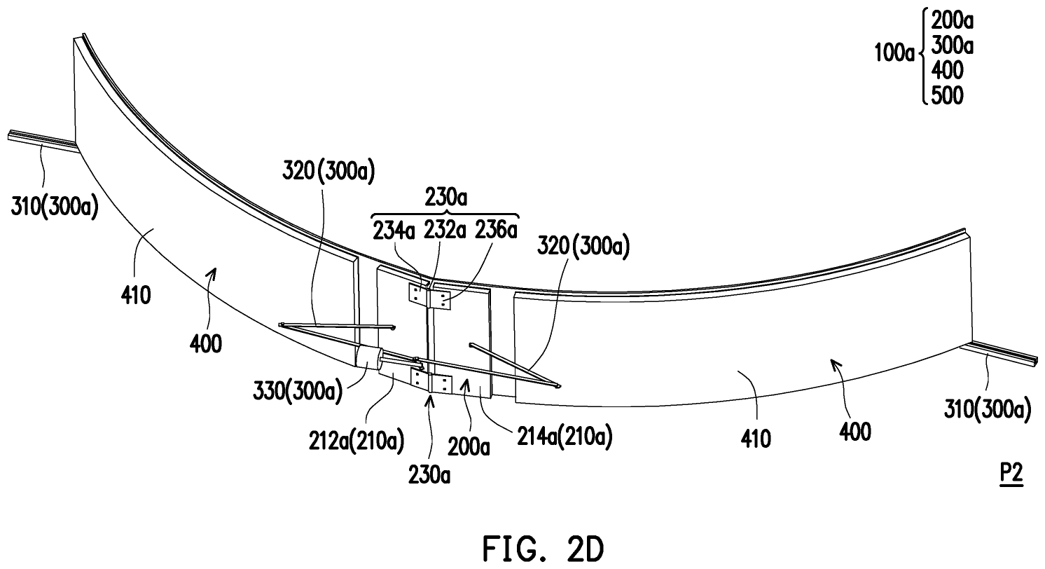

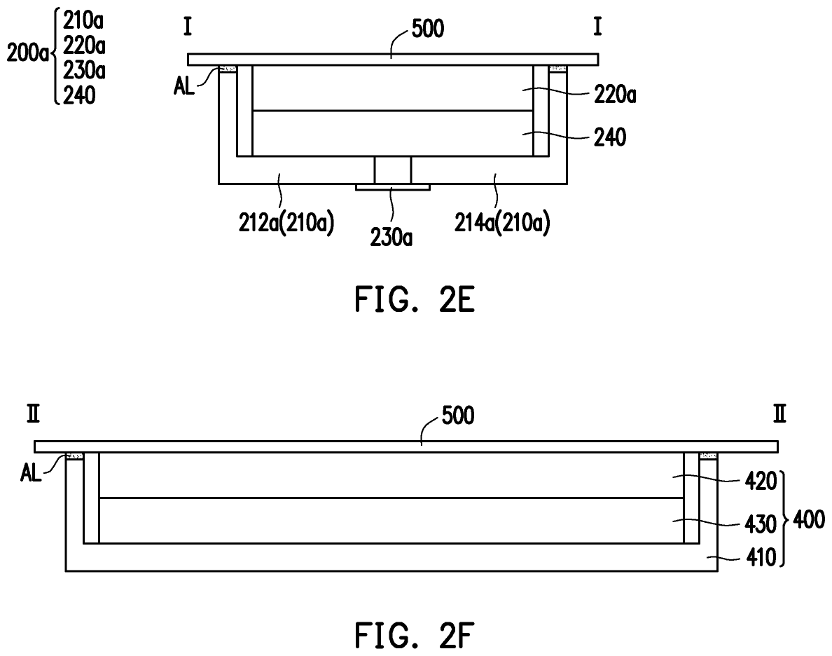

FIG. 1 is a schematic diagram of a vehicle device disposed in a car of an embodiment of the disclosure. FIG. 2A is a schematic three-dimensional diagram of the vehicle device of FIG. 1 in a first position. FIG. 2B is a schematic three-dimensional diagram of FIG. 2A from another perspective. FIG. 2C is a schematic three-dimensional diagram of the vehicle device of FIG. 1 in a second position. FIG. 2D is a schematic three-dimensional diagram of FIG. 2C from another perspective. FIG. 2E is a schematic cross-sectional view along line I-I of FIG. 2B. FIG. 2F is a schematic cross-sectional view along line II-II of FIG. 2B.

Please refer to FIG. 1, FIG. 2A, FIG. 2B, and FIG. 2E at the same time. In the present embodiment, a vehicle device 100a is suitable for installation in a car 10, and may be disposed in front of a driver seat 20 and/or a passenger seat 30. In an embodiment, the vehicle device 100a includes a vehicle body including the dashboard (generally referring to the entire area beneath the windshield between the A-pillars), but it not limited thereto, and display(s) including an instrument cluster display 40, a center information display 50, a passenger display 60, or any combination of the aforementioned displays provided for viewing by the driver and/or the passenger (for example, the front passenger or the rear passenger). In detail, the vehicle device 100a of the present embodiment includes a first display 200a and a control structure 300a. The first display 200a includes a first frame 210a, a first display unit 220a, and a first connecting structure 230a. The first frame 210a includes a first sub-frame 212a and a second sub-frame 214a. The first display unit 220a is disposed on the first frame 210a. The first connecting structure 230a is connected to the first sub-frame 212a and the second sub-frame 214a. The control structure 300a is connected to the first sub-frame 212a and the second sub-frame 214a.

In the present embodiment, the first frame 210a is, for example, a heat spreader that may be cut into the first sub-frame 212a and the second sub-frame 214a. The first sub-frame 212a and the second sub-frame 214a are connected by the first connecting structure 230a such that the first display 200a has flexibility. The first connecting structure 230a is, for example, a hinge with a single rotating shaft and includes one rotating shaft 232a and two door panels 234a and 236a. The first sub-frame 212a and the second sub-frame 214a are respectively fixed on the two door panels 234a and 236a. Moreover, the first display 200a of the present embodiment also includes a first backlight module 240 disposed on the first frame 210a, wherein the first backlight module 240 is located between the first display unit 220a and the first frame 210a, and the first frame 210a is used to place the first backlight module 240. That is, the first display 200a of the present embodiment is a non-self-luminous display, and the first display unit 220a may be, for example, a liquid-crystal display (LCD), but the disclosure is not limited thereto. In another embodiment not shown, the first display may also be a self-luminous display. The first display may be, for example, an organic light-emitting diode (OLED) display, a micro-LED display, a mini-LED display, or a quantum dot LED display, but the disclosure is not limited thereto. In an embodiment, the first display unit 220a and the first backlight module 240 may both be flexible, and the first frame 210a is flexible by the first connecting structure 230a. In an embodiment, a single first frame may also have a crack relief groove dug in the middle of the structure to make the first display flexible, wherein the location of the crack relief groove is usually the place to be bent. In an embodiment, the first frame 210a may achieve a bending effect through other mechanical designs or by utilizing flexible materials.

Please refer to FIG. 2A and FIG. 2B at the same time. The vehicle device 100a of the present embodiment also includes a second display 400 adjacent to the first display 200a, wherein the second display 400 is a curved display. Here, the number of the second display 400 is schematically shown as two, wherein the first display 200a is located between the two second displays 400. As shown in FIG. 1, the arrangement direction of the first display 200a and the second displays 400 is, for example, the same as the arrangement direction of the driver seat 20 and the passenger seat 30. In an embodiment, at least one of the first display 200a and the second displays 400 is a portion of the instrument cluster display 40, but the disclosure is not limited thereto. The arrangement of the first display 200a and the second displays 400 may form a tiled display screen.

Please refer to FIG. 2F. Each of the second displays 400 of the present embodiment includes a frame 410, a display unit 420, and a backlight module 430, wherein the display unit 420 and the backlight module 430 are disposed on the frame 410, and the backlight module 430 is located between the display unit 420 and the frame 410. The frame 410, the display unit 420, and the backlight module 430 may all be flexible. That is, each of the displays in the present embodiment is formed by one display unit, one backlight module, and one frame. It should be noted that the backlight module may be, for example, a direct backlight module or a side-lit backlight module, but the disclosure is not limited thereto. The backlight module may include a light source, a light guide plate, a reflective sheet, an optical film, or a combination of the above.

In addition, please refer to FIG. 2A, the vehicle device 100a further includes a cover plate 500 covering the first display 200a and the second displays 400 at the same time. As shown in FIG. 2E, the first sub-frame 212a and the second sub-frame 214a of the first display 200a may be assembled with the cover plate 500 by an adhesive layer AL. As shown in FIG. 2F, the frame 410 of the second displays 400 may be assembled with the cover plate 500 by the adhesive layer AL. In an embodiment, the cover plate 500 may be, for example, glass, with a thickness of, for example, 0.5 mm to 1.5 mm, and a radius of curvature, for example, greater than or equal to 100 mm. In an embodiment, the cover plate 500 may be, for example, plastic, with a thickness of, for example, 0.3 mm to 2.0 mm, and a radius of curvature, for example, greater than 10 mm. Here, the cover plate 500 may be flexible. In an embodiment, the cover plate 500 may be a combination of glass and plastic, but the disclosure is not limited thereto.

Please refer to FIG. 2A, FIG. 2B, FIG. 2C, and FIG. 2D at the same time. In the present embodiment, the control structure 300a includes a guide rail 310, two connecting rods 320, and a driver 330. Each of the second displays 400 is disposed on the guide rail 310. In an embodiment, the guide rail 310 may be located on the vehicle body 70 (please refer to FIG. 1) or in the vehicle body 70, wherein the guide rail 310 may control the deformation range of the first display 200a and the second displays 400. The two connecting rods 320 are respectively connected to the first sub-frame 212a and the second sub-frame 214a of the first display 200a. The driver 330 is connected to the two connecting rods 320 to drive the two connecting rods 320 to pull the first frame 210a (for example, to pull the first sub-frame 212a and the second sub-frame 214a), such that the second displays 400 are moved along the guide rail 310 to deform the first display 200a from the first shape to the second shape. In an embodiment, the driver 330 is, for example, a motor, and may be located on the vehicle body 70 (please refer to FIG. 1) or in the vehicle body 70, but the disclosure is not limited thereto.

Furthermore, please refer to FIG. 2A and FIG. 2B at the same time. When the vehicle device 100a is located at a first position P1, the driver 330 of the control structure 300a is not activated, and the connecting rods 320 are in an extended state, so the first display 200a is in the first shape. The first shape may be, for example, M-shaped, but the disclosure is not limited thereto. At this time, the entirety of one second display 400, a portion of one second display 400, or a portion of one second display 400 and first display 200a corresponds to the driver, and the entirety of the other second display 400, a portion of the other second display 400, or another portion of the other second display 400 and the first display 200a corresponds to the passenger. For example, the first shape has at least two distinct areas, wherein the middle of the shape may have a bend, that is, have different extending directions, but the disclosure is not limited thereto.

Next, please refer to FIG. 2C and FIG. 2D, the driver 330 of the control structure 300a is activated to drive the two connecting rods 320 to pull the first frame 210a (for example, pull the first sub-frame 212a and the second sub-frame 214a) to move the second display 400 from the first position P1 (please refer to FIG. 2A and FIG. 2B) to a second position P2 along the guide rail 310. At this time, the connecting rods 320 are in a contracted state, and the first display 200a is deformed from the first shape to the second shape by the control structure 300a. The second shape is, for example, an arc shape, wherein the first display 200a and the two second displays 400 simultaneously correspond to the driver and the passenger. For example, there may be no bend in the middle of the second shape, and all displays correspond to the driver and the passenger, but the disclosure is not limited thereto. In an embodiment, the radius of curvature of the first display 200a may be, for example, greater than or equal to 10 mm, showing a slight V-shape, but the disclosure is not limited thereto.

The deformation operation of the vehicle device 100a is done by the control interface in the vehicle host computer. The first position P1 and the second position P2 are set on the control interface. First, whether the first position P1 is already selected is determined using a positioning sensor. In an embodiment, the positioning sensor may include a camera, a pressure sensor or other suitable sensors, but the disclosure is not limited thereto. If already at the first position P1, no action is taken; if not at the first position P1, the driver 330 of the control structure 300a is activated for operation, and the presence of resistance is determined. If the pressure sensor detects resistance, such as failure to open smoothly or emergency braking, the action is stopped; if no resistance is encountered, the vehicle device 100a is driven to be at the first position P1, such that the first display 200a and the second displays 400 are in the first shape. Similarly, first, whether the second position P2 is already selected is determined using a positioning sensor. If already at the second position P2, no action is taken; if not at the second position P2, the driver 330 of the control structure 300a is activated for operation, and the presence of resistance is determined. If the pressure sensor detects resistance, such as failure to open smoothly or emergency braking, the action is stopped; if no resistance is encountered, the vehicle device 100a is driven to be at the second position P2, such that the first display 200a and the second display 400 are in the second shape.

In short, the first display 200a and the second displays 400 of the present embodiment may be deformed from the first shape to the second shape by the control structure 300a. That is, the appearance of the screen may be changed by mechanical design and an electronic control switch. Therefore, the vehicle device 100a of the present embodiment may provide images from different directions such that the driver and/or the passenger may have a better visual experience.

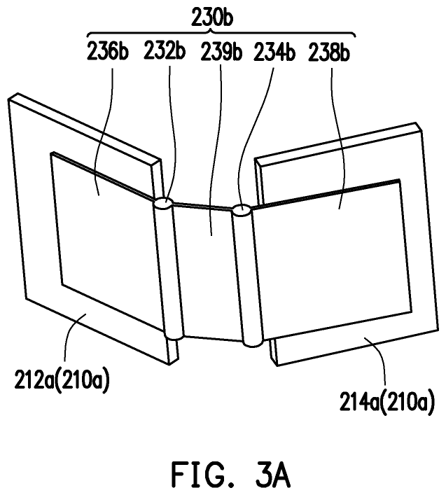

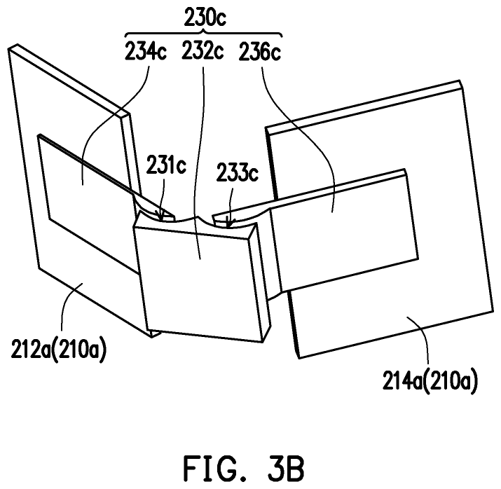

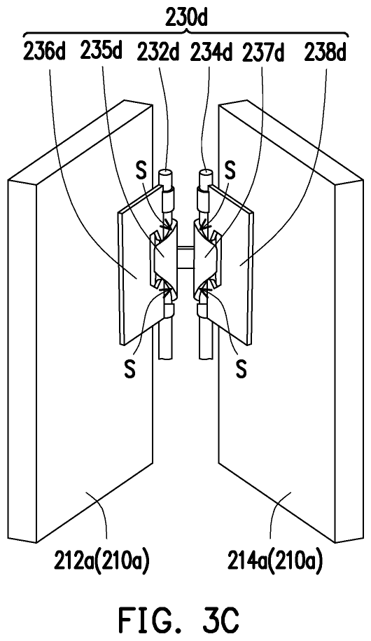

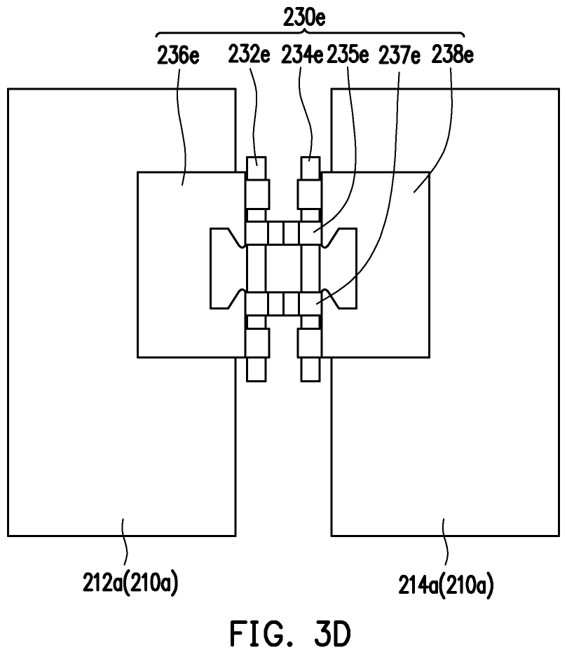

It should be noted that the first connecting structure 230a of the above embodiment adopts a single-axis hinge as an example, but the disclosure is not limited thereto. FIG. 3A to FIG. 3D are schematic three-dimensional diagrams of various first connecting structures and first frames of a plurality of embodiments of the disclosure.

Please refer to FIG. 3A first. In the present embodiment, the first connecting structure 230b is, for example, a dual-shaft hinge, including two rotating shafts 232b and 234b and three door panels 236b, 238b, and 239b. The door panel 239b is located between the rotating shaft 232b and the rotating shaft 234b, the door panel 236b is fixed on the first sub-frame 212a, and the door panel 238b is fixed on the second sub-frame 214a. The arrangement of the first connecting structure 230b allows the first sub-frame 212a or the second sub-frame 214a to be rotated individually, or simultaneously allows the first sub-frame 212a and the second sub-frame 214a to be rotated together.

Next, please refer to FIG. 3B. In the present embodiment, the first connecting structure 230c is, for example, a slide rail-type hinge, including a body 232c and two door panels 234c and 236c. The body 232c has two slideways 231c and 233c, the two door panels 234c and 236c are respectively slid in the two slideways 231c and 233c, the door panel 234c is fixed on the first sub-frame 212a, and the door panel 236c is fixed on the second sub-frame 214a. The door panels 234c and 236c may slide relative to the two slideways 231c and 233c, such that the first sub-frame 212a and the second sub-frame 214a are relatively unfolded or relatively close.

Then, please refer to FIG. 3C. In the present embodiment, the first connecting structure 230d is, for example, a slide block-shaped hinge, including two rotating shafts 232d and 234d, two door panels 236d and 238d, and two slide blocks 235d and 237d. The two door panels 236d and 238d and the two slide blocks 235d and 237d are respectively sleeved on the two rotating shafts 232d and 234d, and the two slide blocks 235d and 237d are connected to each other. The slide blocks 235d and 237d have a slope S design to guide and configure the two door panels 236d and 238d. Here, the slide blocks 235d and 237d are designed to allow the two door panels 236d and 238d to be rotated synchronously. The door panel 236d is fixed on the first sub-frame 212a, the door panel 238d is fixed on the second sub-frame 214a, and the two door panels 236d and 238d may be rotated synchronously, such that the first sub-frame 212a and the second sub-frame 214a are relatively unfolded or relatively close.

Lastly, please refer to FIG. 3D. In the present embodiment, the first connecting structure 230e is, for example, a gear-shaped hinge, including two rotating shafts 232e and 234e, two door panels 236e and 238e, and two gear sets 235e and 237e. The two door panels 236e and 238e and the two gear sets 235e and 237e are respectively sleeved on the two rotating shafts 232e and 234e, wherein the gear sets 235e and 237e may allow the two door panels 236d and 238d to be rotated synchronously. Each of the gear sets 235e and 237e is formed by four gears, for example, but the disclosure is not limited thereto. The door panel 236e is fixed on the first sub-frame 212a, the door panel 238e is fixed on the second sub-frame 214a, and the two door panels 236e and 238e may be rotated synchronously, such that the first sub-frame 212a and the second sub-frame 214a are relatively unfolded or relatively close.

It is worth mentioning that the first connecting structures 230a, 230b, 230c, 230d, and 230e among various embodiments may be mixed and matched as long as they do not violate the spirit of the disclosure or conflict with each other.

It must be noted here that the following embodiments adopt the reference numerals and part of the content of the above embodiments, wherein the same reference numerals are used to represent the same or similar elements, and the description of the same technical content is omitted. For the description of the omitted parts, reference may be made to the above embodiments, which is not repeated in the following embodiments.

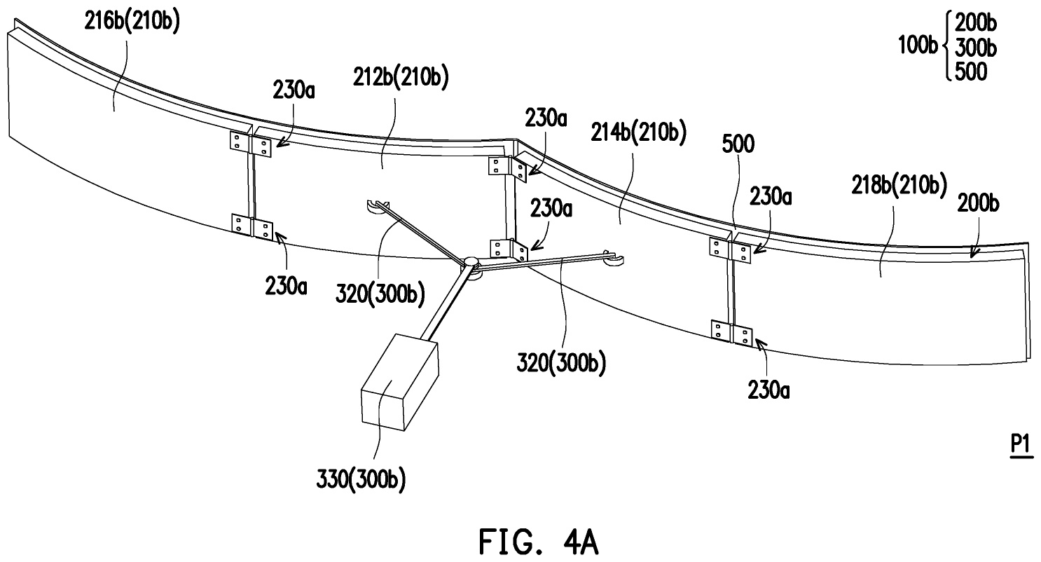

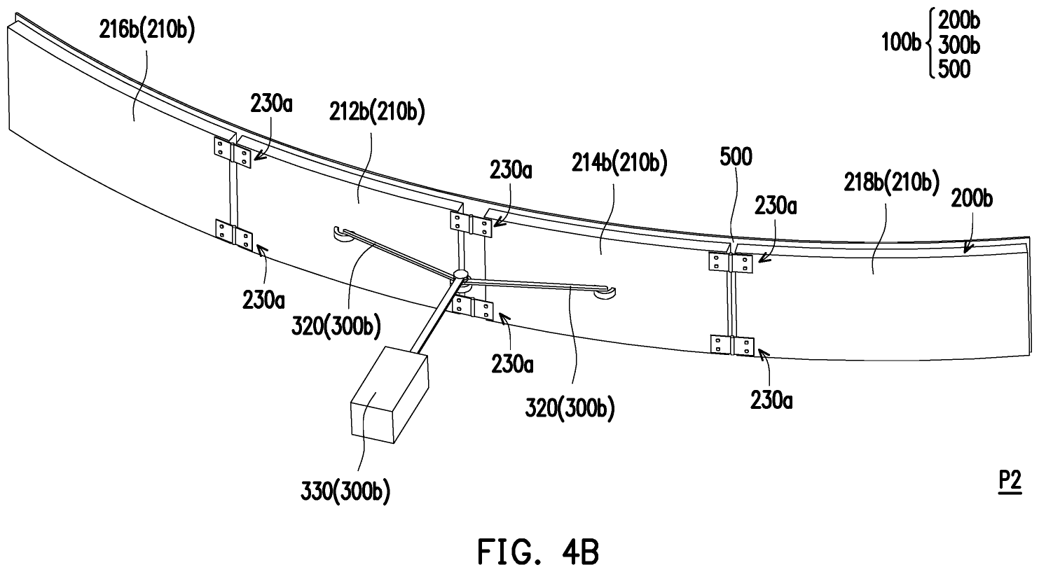

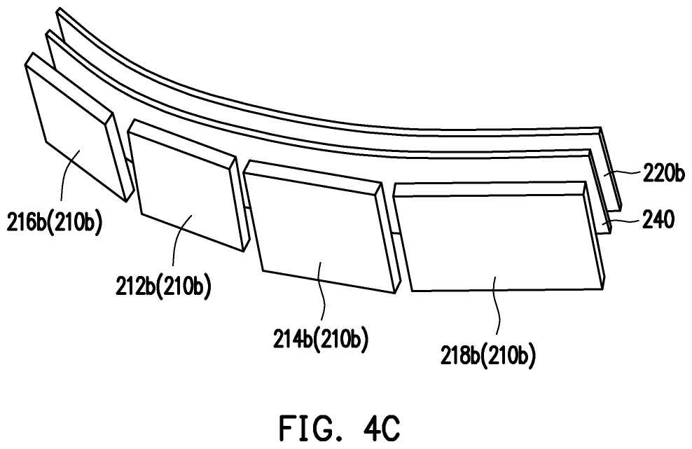

FIG. 4A is a schematic three-dimensional diagram of another vehicle device in a first position of an embodiment of the disclosure. FIG. 4B is a schematic three-dimensional diagram of the vehicle device of FIG. 4A in a second position. FIG. 4C is a schematic three-dimensional exploded diagram of the first display of FIG. 4A. It should be noted that, for convenience of explanation, the first connecting structure is omitted in FIG. 4C.

Please refer to FIG. 2B, FIG. 4A, and FIG. 4C at the same time. A vehicle device 100b of the present embodiment is similar to the vehicle device 100a of FIG. 2B and is not described again here. The difference between FIG. 2B, FIG. 4A, and FIG. 4C is that in the present embodiment, the first display 200b includes a first frame 210b having four sub-frames, one first display unit 220b, a plurality of first connecting structures 230a, and one backlight module 240.

In detail, the first frame 210b of the first display 200b includes a first sub-frame 212b, a second sub-frame 214b, a third sub-frame 216b, and a fourth sub-frame 218b. The first connecting structure 230a is respectively connected to the first sub-frame 212b and the second sub-frame 214b, the second sub-frame 214b and the fourth sub-frame 218b, and the first sub-frame 212b and the third sub-frame 216b. The control structure 300b includes the two connecting rods 320 and the driver 330. The two connecting rods 320 are connected to the first sub-frame 212b and the second sub-frame 214b respectively. The driver 330 is connected to the two connecting rods 320 to drive the two connecting rods 320 to pull the first frame 210b (for example, to pull the first sub-frame 212b and the second sub-frame 214b), such that the first display 200b is deformed from the first shape to the second shape. In some embodiments, the control structure 300b further includes a guide rail, and the guide rail may control the deformation range or the movement range of the first display 200b (for example, an end of the first display 200b corresponding to the third sub-frame 216b and an end of the first display 200b corresponding to the fourth sub-frame 218b).

Further, please refer to FIG. 4A and FIG. 4B. When the vehicle device 100b is located at the first position P1, the driver 330 of the control structure 300b is not operated. Therefore, the first display 200b is in the first shape, such as an M shape, but the disclosure is not limited thereto. When the driver 330 of the control structure 300b is activated to drive the two connecting rods 320 to pull the first frame 210b (for example, pull the first sub-frame 212b and the second sub-frame 214b), such that the vehicle device 100b is moved from the first position P1 to the second position P2, the first display 200b is deformed from the first shape to the second shape, such as an arc shape, by the control structure 300b, such that the first display 200b corresponds to the driver and the passenger.

In some embodiments, the vehicle device 100b further includes a cover plate covering the first display 200b. The first frame 210b of the first display 200b may be assembled with the cover plate by an adhesive layer. The material and the characteristics of the cover plate are as provided in the above embodiments and are not described in detail here.

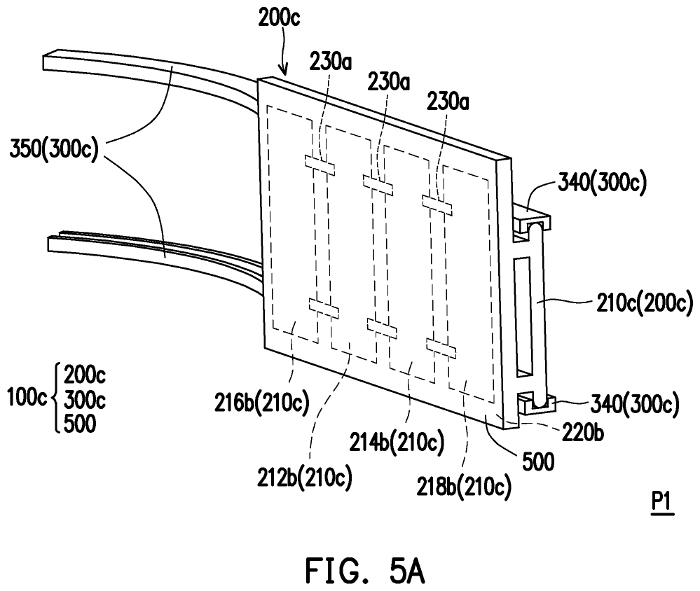

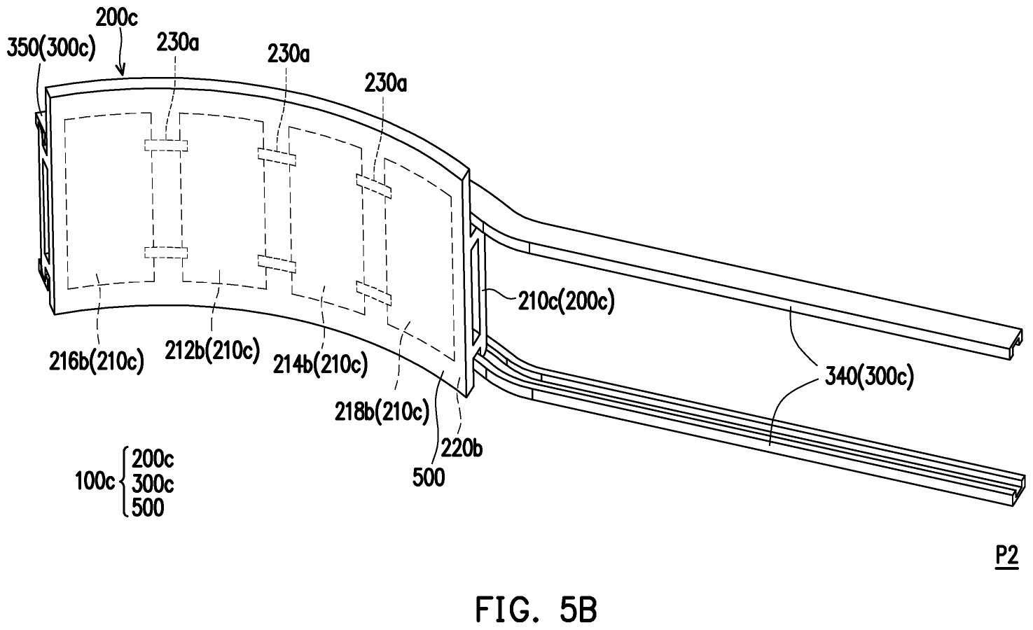

FIG. 5A is a schematic three-dimensional diagram of another vehicle device in a first position of an embodiment of the disclosure. FIG. 5B is a schematic three-dimensional diagram of the vehicle device of FIG. 5A in a second position. Please refer to FIG. 4A and FIG. 5A at the same time. A vehicle device 100c of the present embodiment is similar to the vehicle device 100b of FIG. 4A and is not described again here. The difference between FIG. 4A and FIG. 5A is that in the present embodiment, the first frame 210c of the first display 200c is a connecting frame, and the control structure 300c is a fixed track including a straight track portion 340 and a curved track portion 350 connected to each other. The first frame 210c includes a plurality of sub-frames, such as the first sub-frame 212b, the second sub-frame 214b, the third sub-frame 216b, and the fourth sub-frame 218b. The first connecting structure 230a is respectively connected to the first sub-frame 212b and the second sub-frame 214b, the second sub-frame 214b and the fourth sub-frame 218b, and the first sub-frame 212b and the third sub-frame 216b. The plurality of sub-frames of the first frame 210c are slidably mounted on the control structure 300c, such that the first display 200c is deformed from the first shape to the second shape by the control structure 300c.

In some embodiments, the vehicle device 100c further includes a cover plate covering the first display 200c. The first frame 210c of the first display 200c may be assembled with the cover plate by an adhesive layer. The material and the characteristics of the cover plate are as provided in the above embodiments and are not described in detail here.

Please refer to FIG. 5A and FIG. 5B. When the vehicle device 100c is located at the first position P1, the first frame 210c is slidably mounted on the straight track portion 340, such that the first display 200c is in the first shape, such as a plane shape. When the vehicle device 100c is slid along the fixed track to the second position P2, the first frame 210c is located on the curved track portion 350, such that the first display 200c is in the second shape, such as a curved shape. In short, the first display 200c is moved along the control structure 300c (i.e., the fixed track) and simultaneously deformed along the control structure 300c.

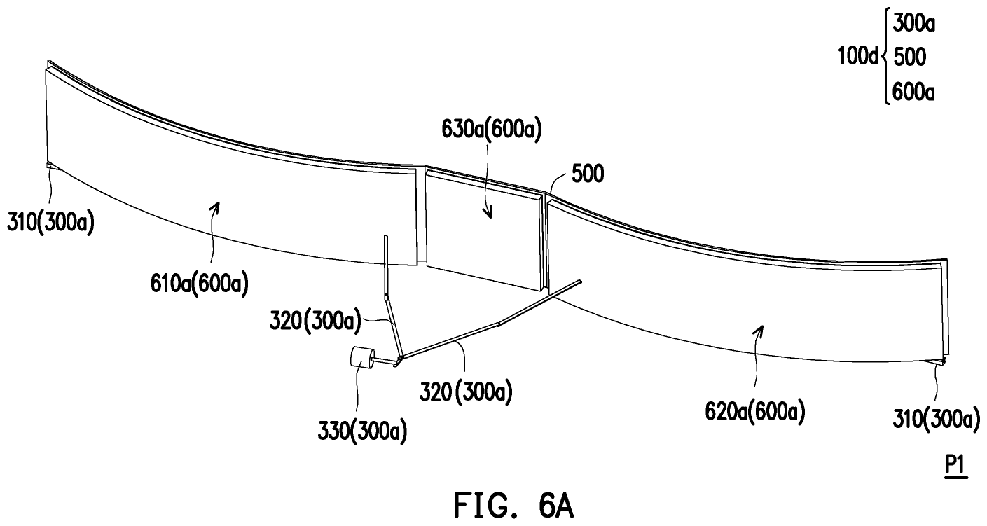

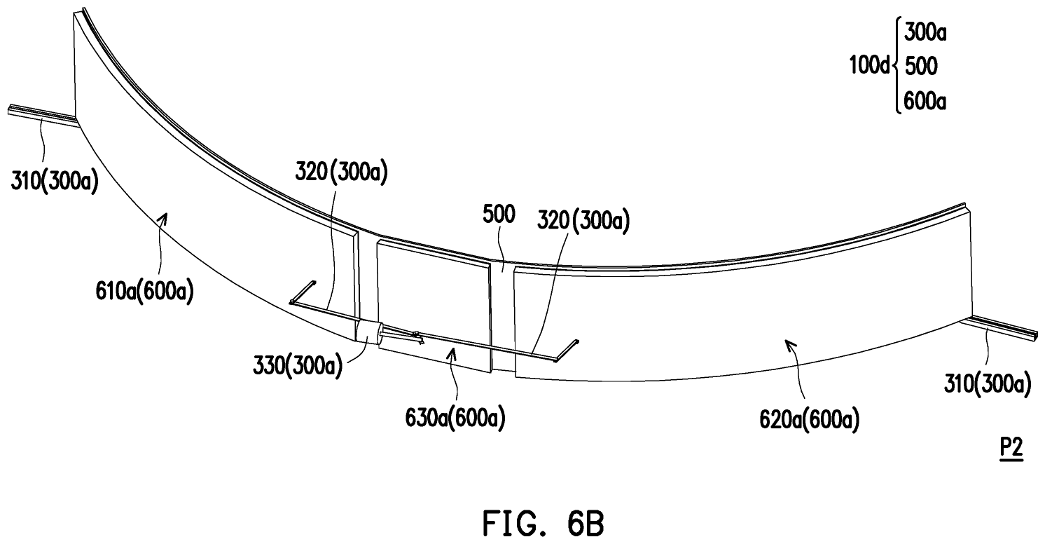

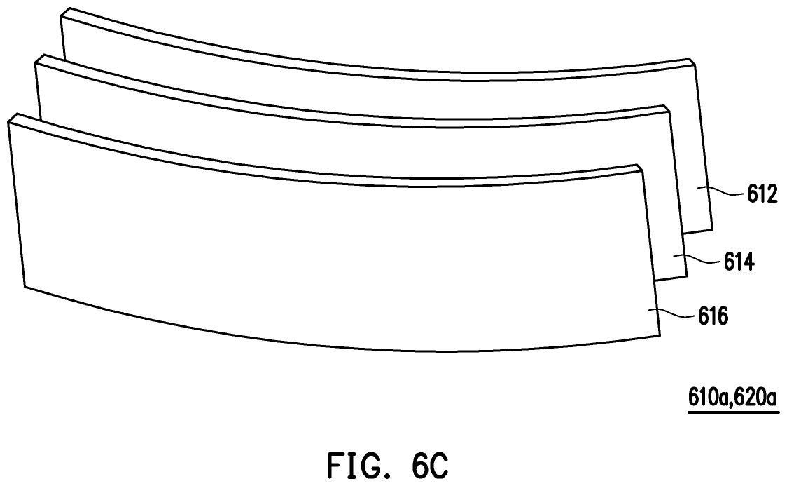

FIG. 6A is a schematic three-dimensional diagram of another vehicle device in a first position of an embodiment of the disclosure. FIG. 6B is a schematic three-dimensional diagram of the vehicle device of FIG. 6A in a second position. FIG. 6C is a schematic three-dimensional exploded diagram of one display of FIG. 6A. Please refer to FIG. 2B and FIG. 6A at the same time. A vehicle device 100d of the present embodiment is similar to the vehicle device 100a of FIG. 2B and is not described again here. The difference between FIG. 2B and FIG. 6A is that in the present embodiment, the vehicle device 100d includes a plurality of displays 600a, the cover plate 500, and the control structure 300a. The plurality of displays 600a include a first curved display 610a and a second curved display 620a. The cover plate 500 covers the plurality of displays 600a. The material and the characteristics of the cover plate are as provided in the above embodiments and are not described in detail here. The control structure 300a is connected to the first curved display 610a and the second curved display 620a, wherein the plurality of displays 600a are deformed from a first shape to a second shape by the control structure 300a.

In detail, please refer to FIG. 6A, FIG. 6B, and FIG. 6C at the same time. In the present embodiment, the plurality of displays 600a also include a flat display 630a disposed between the first curved display 610a and the second curved display 620a. That is, the first curved display 610a, the flat display 630a, and the second curved display 620a may be tiled to form a tiled screen. Each of the plurality of displays 600a includes a display unit 612, a backlight module 614, and a frame 616, wherein the display unit 612 and the backlight module 614 are disposed on the frame 616, and the backlight module 614 is disposed between the display unit 612 and the frame 616. That is, each of the displays in the present embodiment is formed by one display unit, one backlight module, and one frame. The frame 616, the display unit 612, and the backlight module 614 of the first curved display 610a and the second curved display 620a may all be flexible. Here, the backlight module may be, for example, a direct backlight module or a side-lit backlight module, but the disclosure is not limited thereto. The backlight module may include a light source, a light guide plate, a reflective sheet, an optical film, or a combination of the above. In another embodiment not shown, the plurality of displays 600a may also be self-luminous displays, but the disclosure is not limited thereto. In the present embodiment, the flat display 630a may correspond to, for example, the center information display 50 in FIG. 1, while the first curved display 610a and the second curved display 620a may correspond to, for example, the instrument cluster display 40 and the passenger display 60 in FIG. 1, respectively.

Further, please refer to FIG. 6A and FIG. 6B. When the vehicle device 100d is located at the first position P1, the driver 330 of the control structure 300a is not operated. Therefore, the displays 600a are in the first shape, such as an M shape, but the disclosure is not limited thereto. When the driver 330 of the control structure 300a is activated to drive the two connecting rods 320 to pull the first curved surface display 610a and the second curved surface display 620a, the first curved surface display 610a and the second curved surface display 620a are moved from the first position P1 to the second position P2 along the guide rail 310. At this time, the connecting rods 320 are in a contracted state, and the displays 600a are deformed from the first shape to a second shape, such as an arc shape, by the control structure 300a, such that the displays 600a correspond to the driver and the passenger. In an embodiment, the guide rail 310 may be located on the vehicle body 70 (please refer to FIG. 1) or in the vehicle body 70. In an embodiment, the driver 330 is, for example, a motor, and may be located on the vehicle body 70 or in the vehicle body 70.

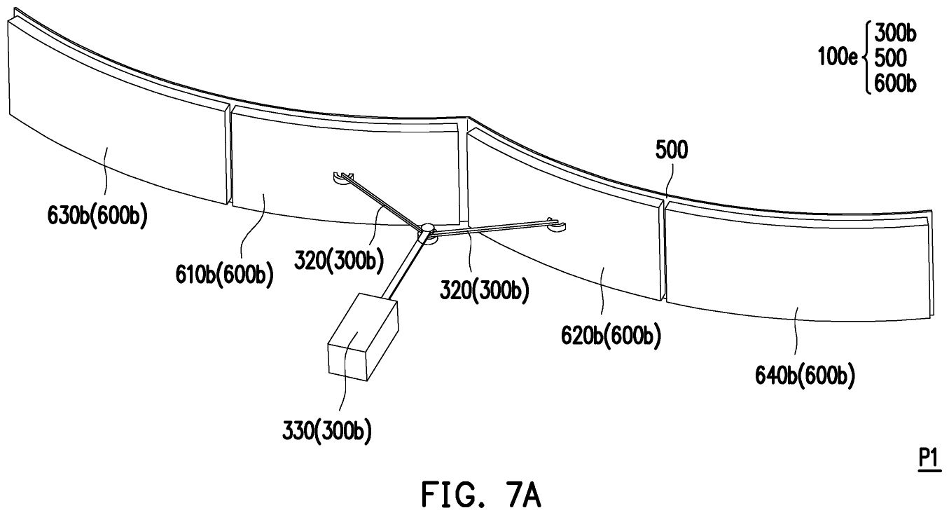

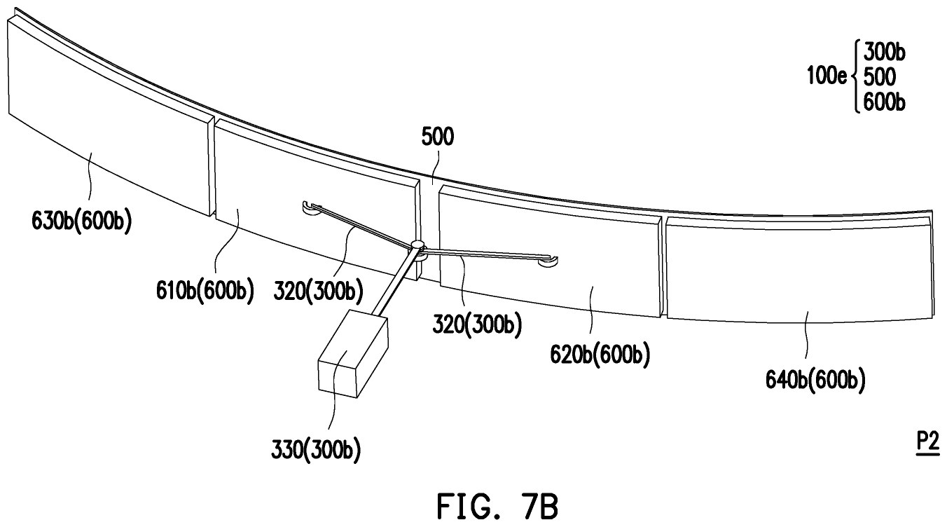

FIG. 7A is a schematic three-dimensional diagram of another vehicle device in a first position of an embodiment of the disclosure. FIG. 7B is a schematic three-dimensional diagram of the vehicle device of FIG. 7A in a second position. Please refer to FIG. 6A and FIG. 7A at the same time. A vehicle device 100e of the present embodiment is similar to the vehicle device 100d of FIG. 6A and is not described again here. The difference between FIG. 6A and FIG. 7A is that in the present embodiment, a plurality of displays 600b include four curved surface displays 610b, 620b, 630b, and 640b. Each of the displays in the present embodiment is formed by one display unit, one backlight module, and one frame, wherein the frame, the display unit, and the backlight module may all be flexible. In another embodiment not shown, the plurality of displays 600b may also be self-luminous displays. The control structure 300b is connected to two curved surface displays (such as the curved surface display 610b and the curved surface display 620b, but the disclosure is not limited thereto), wherein the displays 600b are deformed from a first shape to a second shape by the control structure 300b.

Further, please refer to FIG. 7A and FIG. 7B. When the vehicle device 100c is located at the first position P1, the driver 330 of the control structure 300b is not operated. Therefore, the displays 600b are in the first shape, such as an M shape, but the disclosure is not limited thereto. When the driver 330 of the control structure 300b is activated to drive the two connecting rods 320 to pull the curved display 610b and the curved display 620b, the vehicle device 100e is moved from the first position P1 to the second position P2, and the displays 600b are deformed from the first shape to a second shape, for example, an arc shape, by the control structure 300b, such that the displays 600b correspond to the driver and the passenger. In some embodiments, the control structure 300b further includes a guide rail. The guide rail may control the deformation range or the movement range of the plurality of displays 600b. Based on the above, in an embodiment of the disclosure, the display may be deformed from the first shape to the second shape by the control structure, meaning that the screen appearance may be changed. Therefore, the vehicle device of the disclosure may provide images from different directions such that the driver and/or the passenger may have a better visual experience.

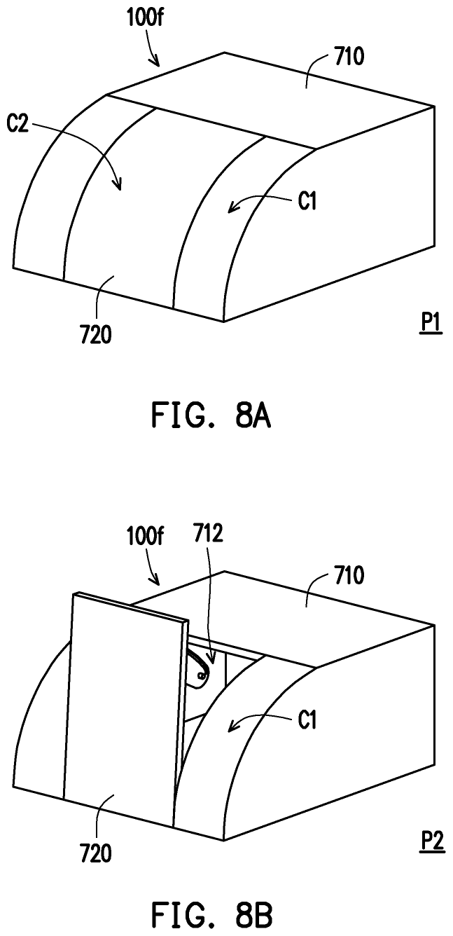

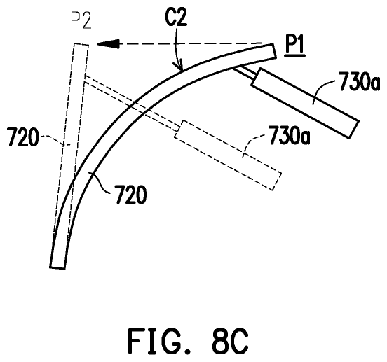

FIG. 8A is a schematic three-dimensional diagram of another vehicle device in a first position of an embodiment of the disclosure. FIG. 8B is a schematic three-dimensional diagram of the vehicle device of FIG. 8A in a second position. FIG. 8C is schematic diagram illustrating the display and the control structure in the first position and the second position as shown in FIG. 8A and FIG. 8B. It should be noted that FIG. 8A and FIG. 8B depict partial areas of the vehicle body 70 shown in FIG. 1.

Please refer to FIG. 8A, FIG. 8B and FIG. 8C at the same time. In the present embodiment, a vehicle device 100f includes a vehicle body 710, a display 720 and a control structure 730. The vehicle body 710 has a first curved shape C1 and includes a cavity 712. The display 720 is disposed within the cavity 712, wherein the display 720 of this embodiment is the same as the display 600a of FIG. 6C, and includes the frame 616, the backlight module 614 and the display unit 612. The backlight module 614 is disposed on the frame 616, and the display unit 612 is disposed on the backlight module 614. In an embodiment, the display 720 of this embodiment may be as the same as the display of FIG. 1, and may be include the instrument cluster display 40, the center information display 50, the passenger display 60, or any combination of the aforementioned displays provided for viewing by the driver and/or the passenger (for example, the front passenger or the rear passenger). In an embodiment, the display unit 612 and the backlight module 614 may both be flexible, and the frame 616 is flexible by the connecting structure 730a. In an embodiment, a single frame may also have a crack relief groove dug in the middle of the structure to make the display flexible, wherein the location of the crack relief groove is usually the place to be bent. In an embodiment, the frame 616 may achieve a bending effect through other mechanical designs or by utilizing flexible materials.

The control structure 730a is disposed within the cavity 712 and connected to the display 720, wherein the display 720 is deformed from a first shape to a second shape by the control structure 730a. In an embodiment, the control structure 730a is, for example, an electric cylinder. In an embodiment, one of the first shape and the second shape is a plane shape, and the other of the first shape and the second shape is a curved shape. Furthermore, when the vehicle device 100f is located at the first position P1, the control structure 730a is not activated, so the display 720 is in the first shape. The first shape may be, for example, curved shape, but the disclosure is not limited thereto. In an embodiment, the display 720 has a second curved shape C2 at the first shape, and the first curved shape C1 is adjacent to the second curved shape C2, and a curvature of the first curved shape C1 is the same as a curvature of the second curved shape C2. The control structure 730a is activated to move the display 720 from the first position P1 to the second position P2, the display 720 is deformed from the first shape to the second shape by the control structure 730a. The second shape is, for example, a plane shape, for driver/passenger (for example, the front passenger or the rear passenger) to view or operate easily. Herein, the display 720 and the vehicle body 710 have different shapes, e.g. different curvatures.

In short, the display 720 of the present embodiment may be deformed from the first shape to the second shape by the control structure 730a. That is, the appearance of the screen may be changed by electronic control switch. Therefore, the vehicle device 100f of the present embodiment may provide images from different directions such that the driver and/or the passenger may have a better visual experience.

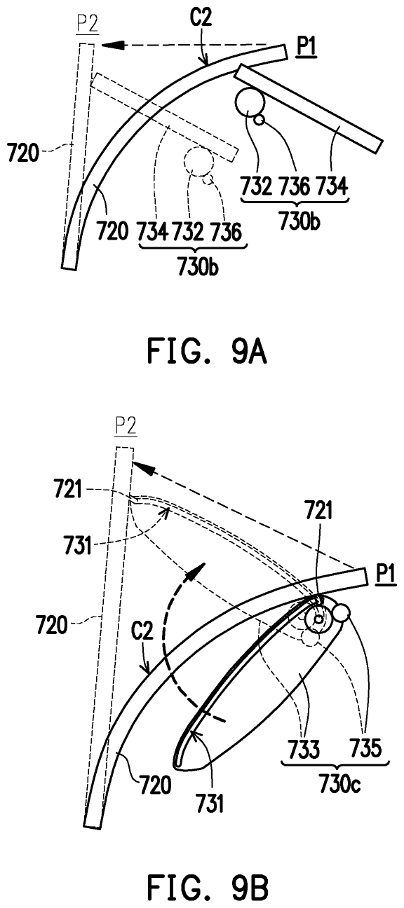

It should be noted that the connecting structure 730a of the above embodiment adopts an electric cylinder as an example, but the disclosure is not limited thereto. FIG. 9A to FIG. 9B are schematic diagram illustrating the display and various control structure in the first position and the second position.

Please refer to FIG. 9A first. In the present embodiment, the control structure 730b is, for example, a combination of a gear 732, a rack 734 and a motor 736. The rack 734 is connected to the display 720, and the gear 732 is connected to the display 720. To more specific, the gear 732 is, for example, located on the drive shaft of the motor 736 and connected to the rack 734. The gears of the motor 736 engager with the gear 732 to drive the gear 732 to move the rack 734 to deform the display 720 from the first shape (i.e. curved shape at the first position P1) to the second shape (i.e. plane shape at the second position P2).

Lastly, please refer to FIG. 9B. In the present embodiment, the control structure 730c is, for example, a combination of a cam 733 and a motor 735. The cam 733 is connected to the connecting member 721 of the display 720, and the motor 735 is connected to the cam 733, wherein the cam 733 has a groove 731. To more specific, the gears of the motor 735 drive the gear of the cam 733 to rotate, and the connecting member 721 of the display 720 can slide in the groove 731 of the cam 733, thereby deforming the display 720 from the first shape (i.e. curved shape at the first position P1) to the second shape (i.e. plane shape at the second position P2).

Lastly, it should be noted that the above embodiments are used to describe the technical solutions of the disclosure instead of limiting them. Although the disclosure has been described in detail with reference to each embodiment above, those having ordinary skill in the art should understand that the technical solution recited in each embodiment above may still be modified, or some or all of the technical features thereof may be equivalently replaced. These modifications or replacements do not make the essence of the corresponding technical solutions depart from the scope of the technical solution of each embodiment of the disclosure.

What is claimed is:

1. A vehicle device, comprising:
a first display, comprising:
a first frame comprising a first sub-frame and a second sub-frame;
a first display unit disposed on the first frame; and
a first connecting structure connected to the first sub-frame and the second sub-frame; and
a control structure connected to the first sub-frame and the second sub-frame, wherein the first display is deformed from a first shape to a second shape by the control structure.

2. The vehicle device of claim 1, wherein the first display further comprises a first backlight module disposed between the first frame and the first display unit.

3. The vehicle device of claim 1, further comprising:
a second display adjacent to the first display, wherein the second display is a curved display.

4. The vehicle device of claim 3, wherein the second display comprises a frame, a display unit, and a backlight module, the display unit and the backlight module are disposed on the frame, and the backlight module is located between the display unit and the frame.

5. The vehicle device of claim 3, wherein at least one of the first display and the second display is a portion of an instrument cluster display.

6. The vehicle device of claim 3, further comprising:
a cover plate covering the first display and the second display.

7. The vehicle device of claim 6, wherein the cover plate is a glass, a thickness thereof is 0.5 mm to 1.5 mm, and a radius of curvature thereof is greater than or equal to 100 mm.

8. The vehicle device of claim 6, wherein the cover plate is a plastic, a thickness thereof is 0.3 mm to 2.0 mm, and a radius of curvature thereof is greater than 10 mm.

9. The vehicle device of claim 6, wherein the control structure comprises:
a guide rail, wherein the second display is disposed on the guide rail;
two connecting rods respectively connected to the first sub-frame and the second sub-frame; and
a driver connected to the two connecting rods and used to drive the two connecting rods to pull the first sub-frame and the second sub-frame respectively, such that the second display is moved along the guide rail and the first display is deformed from the first shape to the second shape.

10. The vehicle device of claim 9, wherein the driver is a motor and located on a vehicle body or in a vehicle body.

11. The vehicle device of claim 1, wherein the control structure is a fixed track, the fixed track comprises a straight track portion and a curved track portion connected to each other, and the first display is slid along the fixed track to deform from the first shape to the second shape.

12. The vehicle device of claim 1, wherein the first frame comprises a heat spreader.

13. A vehicle device, comprising:
a plurality of displays comprising a first curved display and a second curved display;
a cover plate covering the plurality of displays; and
a control structure connected to the first curved display and the second curved display, wherein the plurality of displays are deformed from a first shape to a second shape by the control structure.

14. The vehicle device of claim 13, wherein the plurality of displays further comprise a flat display disposed between the first curved display and the second curved display.

15. The vehicle device of claim 13, wherein each of the plurality of displays comprises a display unit, a backlight module, and a frame, and the backlight module is disposed between the display unit and the frame.

16. The vehicle device of claim 13, wherein the control structure comprises:
a guide rail configured to control a deformation range of the plurality of displays;
two connecting rods respectively connected to the first curved display and the second curved display; and
a driver connected to the two connecting rods and used to drive the two connecting rods to pull the first curved display and the second curved display respectively, such that the plurality of displays are deformed from the first shape to the second shape.

17. A vehicle device, comprising:
a vehicle body having a first curved shape and comprising a cavity;
a display disposed within the cavity, and comprising:
a frame;
a backlight module disposed on the frame; and
a display unit disposed on the backlight module; and
a control structure disposed within the cavity and connected to the display, wherein the display is deformed from a first shape to a second shape by the control structure.

18. The vehicle device of claim 17, wherein one of the first shape and the second shape is a plane shape, and the other of the first shape and the second shape is a curved shape.

19. The vehicle device of claim 17, wherein the display has a second curved shape at the first shape, and the first curved shape is adjacent to the second curved shape, and a curvature of the first curved shape is the same as a curvature of the second curved shape.

20. The vehicle device of claim 17, wherein the control structure comprises an electric cylinder, a combination of a gear, a rack and a motor, or a combination of a cam and a motor.
